(19) United States
(12) Patent Application Publication
(10) Pub. No.: US 2009/0025062 A1
(43) Pub. Date: Jan. 22, 2009

(54) Verifying authenticity of conference call invitees

(75) Inventors: Christophe Gustave, Ottawa (CA); Bassem Abdel-Aziz, Kanata (CA); Stanley Taihai Chow, Ottawa (CA)

Correspondence Address: GALASSO & ASSOCIATES, LP, P.O. BOX 26503, AUSTIN, TX, 78755-0503, US

(73) Assignee: ALCATEL LUCENT

(21) Appl. No.: 11/879,452

(22) Filed: Jul. 17, 2007

(51) Int. Cl. G06F 7/04

(52) U.S. Cl. 726/4

(57) ABSTRACT

A conference call server comprises a collection of computer-executable instructions for facilitating conference call authentication functionality. Computer-executable instructions are provided for authenticating a plurality of invitees to a conference call session during the conference call session. Authenticating the plurality of conference call invitees includes cryptographically verifying an identity of each one of the conference call invitees using information associated with a respective authentication certificate. Computer-executable instructions are provided for outputting identification information contained in the authentication certificate of each one of the conference call invitees in response to successful authentication thereof. The identification information is outputted to at least one of the conference call invitees.

### FIELD OF THE DISCLOSURE

The disclosures made herein relate generally to authentication provisions in telephony network systems and, more particularly, to verifying authenticity of conference call invitees.

### BACKGROUND

Thanks to known technology advances and the widespread use of open networks, telephony communications are becoming easy targets for identity theft or information theft. Fraud related to identity theft and information theft schemes is becoming very prevalent in today's intricate telephony (e.g., voice/data) networks Malicious entities are taking advantage of well-established social behavior to gather sensitive personal and/or business information, often in combination with assuming a false identity acquired via identity theft, for use malicious and/or deceitful purposes. Consequences resulting for such theft schemes may be extremely severe, especially when it involves sensitive communications exchanged with business institutions, government agencies, high security contexts (e.g., military) and the like.

Caller ID, as traditionally provided by the switched circuit Public Switched Telephone Network (PSTN), was reasonably secure. However, the introduction of Voice over Internet Protocol (VoIP) has made it relatively simple to change caller ID so that a real identity of a calling party is concealed. Changing caller ID name is referred to as “caller spoofing”, and it is generally done for fraudulent purposes.

In the VoIP domain, caller spoofing is so simple that there are web sites dedicated to permitting anyone to place calls using any caller ID they desire. Examples of such web sites can be found at telespoof.com and spooftel.com. Since it is now possible to originate calls from a VoIP network that are terminated in the PSTN, caller ID can no longer be trusted as a reliable caller authentication system. Spoofing only the displayable Caller ID Name part of Caller ID is even easier, because this can be arbitrarily chosen by the caller either during caller subscription or on a call-by-call basis in VoIP and this cannot be controlled by currently adopted authentication mechanisms, even those available in IP Telephony. Furthermore, even if caller ID name could be authenticated using prior art methods, certain “legitimate” names may be maliciously selected to resemble authentic trusted names, and this creates another opportunity for phishing attacks.

Caller spoofing provides a new way to perpetrate identity theft using a new variation of the old computer phishing attack. In this new variation, instead of using web pages, the identity thief calls the victim, and claims to be calling from a financial institution, for example. The identity thief impersonates an employee of the financial institution and asks for account information and passwords. If the identity thief spoofs the Caller name to appear as if the call is actually originating from the financial institution's telephone system, then there is a higher probability that the thief will succeed in obtaining the information they desire.

Grouping or regrouping a set of voice users in a conference call is no exception to such telephony communications that are targets for identity theft or information theft. Confidential information is often disclosed in conference calls. A malicious entity can misappropriate such confidential information by attending a conference call under false pretences (e.g., misrepresenting themselves as an authorized conference call invitee) or by listening in on a conference call unbeknownst to the conference call invitees. Regardless of the means by which a malicious entity misappropriates such confidential information, the result can be catastrophic to the entity from which the confidential information is misappropriated.

Therefore, to limit the potential for unauthorized attendance in a conference call, a solution that provides for end-to-end authentication of calling parties involved in a conference call and for subsequent near real-time identification of current speaker entity would be advantageous, desirable and useful.

### SUMMARY OF THE DISCLOSURE

Embodiments of the present invention address the problem of a calling party attempting to misappropriate confidential information through unauthorized participation in a conference call, thereby allowing such confidential information to be used for the purpose of committing malicious and/or deceitful acts. More specifically, embodiments of the present invention provide for authentication of identity information corresponding to each party involved in a conference call (i.e., the calling party). Through such authentication, invitees of a conference call can be reasonably assured that all participating parties are known to be participating and are intended invitees. In this manner, the potential for misappropriation of confidential information through unauthorized participation in a conference call is greatly reduced.

In one embodiment of the present invention, a method comprises a plurality of operations for facilitating conference call authentication functionality. An operation is performed for authenticating a plurality of invitees to a conference call session during the conference call session. Authenticating the plurality of conference call invitees includes cryptographically verifying an identity of each one of the conference call invitees using information associated with a respective authentication certificate. An operation is performed for providing identification information contained in the authentication certificate of each one of the conference call invitees in response to successful authentication thereof. The identification information is provided to at least one of the conference call invitees.

In another embodiment of the present invention, a conference call server comprises a collection of computer-executable instructions for facilitating conference call authentication functionality. Computer-executable instructions are provided for authenticating a plurality of invitees to a conference call session during the conference call session. Authenticating the plurality of conference call invitees includes cryptographically verifying an identity of each one of the conference call invitees using information associated with a respective authentication certificate. Computer-executable instructions are provided for outputting identification information contained in the authentication certificate of each one of the conference call invitees in response to successful authentication thereof. The identification information is outputted to at least one of the conference call invitees.

In another embodiment of the present invention, a conference call system is configured to authenticate a plurality of invitees to a conference call session during the conference call session, to determine a discrepancy between a number of authenticated conference call invitees and a number of connected entities during the conference call session, and to adjust a count of authenticated conference call invitees accordingly in response to a change in a respective conference call session state for any one of the authenticated conference call invitees. Authenticating the plurality of conference call invitees includes cryptographically verifying an identity of each one of the conference call invitees using information associated with a respective authentication certificate.

In another embodiment of the present invention, a method comprises a plurality of operations for facilitating conference call authentication functionality. A method is provided for authenticating a plurality of invitees to a conference call session during the conference call session. Authenticating the plurality of conference call invitees includes cryptographically verifying an identity of each one of the conference call invitees using information associated with a respective authentication certificate. An operation is performed for determining a discrepancy between a number of authenticated conference call invitees and a number of connected entities during the conference call session. An operation is performed for adjusting a count of authenticated conference call invitees accordingly in response to a change in a respective conference call session state for any one of the authenticated conference call invitees.

These and other objects, embodiments, advantages and/or distinctions of the present invention will become readily apparent upon further review of the following specification, associated drawings and appended claims.

### BRIEF DESCRIPTION OF THE DRAWINGS

Further features and advantages of the present invention will become apparent from the following detailed description, taken in combination with the appended drawings, in which:

FIG. 1 is an embodiment of a state diagram depicting different states associated to a user

FIGS. 2a and 2b is an embodiment of a method for facilitating authentication of conference call invitees;

FIG. 3 is an embodiment of a method for facilitating verification of participation in a conference call by only authenticated conference call invitees;

FIG. 4 is a schematic diagram of a registration infrastructure and process for caller identity registration;

FIG. 5 is a schematic diagram of a caller authentication infrastructure and process performed by a user device executing a caller authentication application;

FIG. 6 is a schematic diagram of a caller authentication infrastructure and process performed by an IP/PBX executing a caller authentication application;

FIG. 7 is a schematic diagram of a caller authentication infrastructure and process performed by a network gateway executing a caller authentication application;

FIGS. 8a-8c are schematic diagrams of user telephone devices displaying caller authentication messages;

FIGS. 9a-9d are schematic diagrams of different methods of conveying caller authentication indications to called party telephone devices.

FIG. 10 shows various embodiments of conference call targets capable of being configured for engaging in conference call authentication functionality in accordance with the present invention.

It should be noted that throughout the appended drawings, like features are identified by like reference numerals.

### DETAILED DESCRIPTION OF THE DRAWING FIGURES

The present invention relates to an authentication protocol for providing real-time, end-to-end authentication of parties involved into a multi party conference call. More specifically, the invention provides a mean for positively identifying participants of a conference call based on the authenticated caller name associated with entities subscribing to a caller name authentication service. Upon the connection of a new entity or the disconnection of an entity part of the conference call, a notification mechanism advertises the authenticated caller name of the entity to the conference call members. Also, whenever a member of the conference call starts speaking, its authenticated caller name is broadcasted to the conference call members. Preferably, but not necessarily, spread spectrum signals are used facilitating transmission of information associated with the authentication protocol. Spread spectrum using wide band signals and featuring low probability of intercept (LPI) and anti-jam (AJ), which makes it a good candidate for the purpose of authenticating voice users in a conference call.

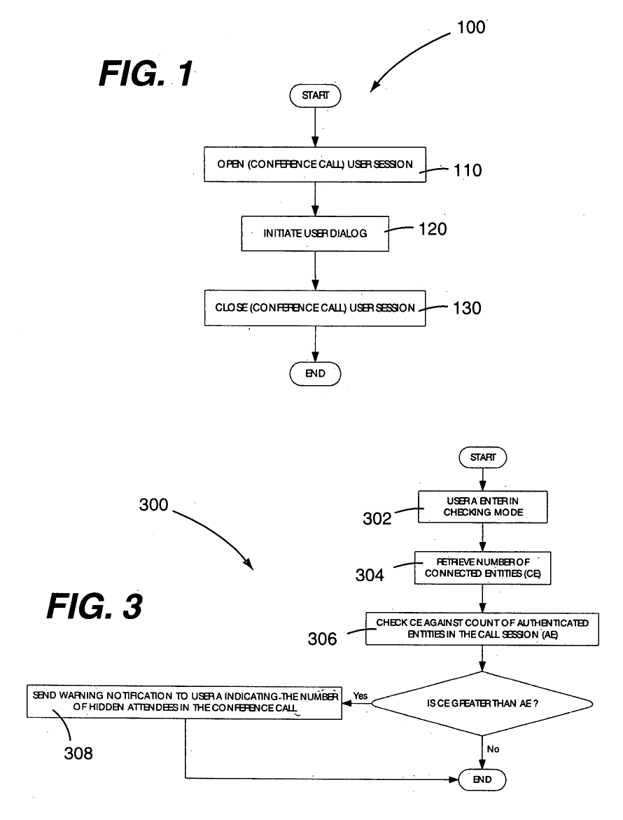

Referring now to the drawing figures, FIG. 1 shows an embodiment of a state diagram 100 depicting different states associated to a user in a conference call. Such states are referred to herein as conference call session states. An Open User Session State 110 corresponds to a user connecting to the conference call. A user enters into an Initiate Dialog State 120 when starting to speak on the conference call. A user enters into a Close User Session State 130 upon leaving the conference call.

Upon entering into one of the conference call states shown in FIG. 1, the equipment at the user premises is required to send a new “state” notification message along with the authentication data associated with that user. The state notification message designates the current state of the user. The authentication data associated with that user is provided an authentication process for the user being facilitated by the user premises equipment. In one embodiment of authenticating the user, the user premises equipment retrieves a public key certificate (i.e., authentication certificate) for that user and cryptographically computes a digital signature of that certificate, using a corresponding private key and incorporating any necessary additional material to prevent from potential replay attacks. The authentication data comprising the authentication certificate and the digital signature is sent along via the voice path and carried through the call server to all the other conference call invitees. An alternative embodiment of implementing authentication functionality in accordance with the present invention includes authenticating a conference call invitee on-demand, upon request from the chair, or each time a conference call invitee start a dialog after coming back from an idle state. Another alternative embodiment of implementing authentication functionality in accordance with the present invention includes the system performing such functionality being set up in a way that all conference call invitees are required to be re-authenticated after a configured amount of time.

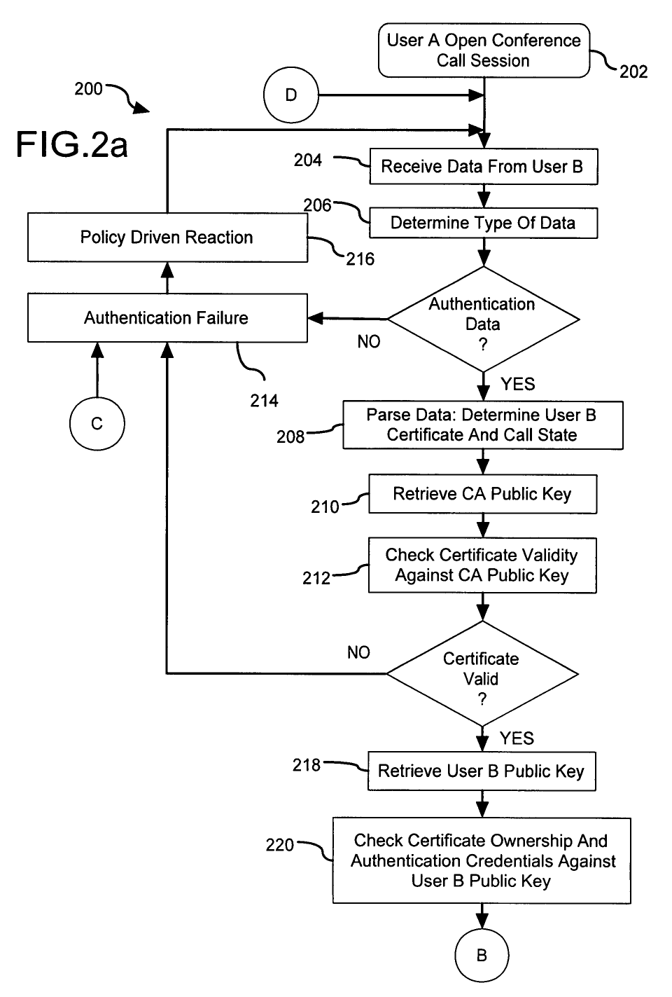

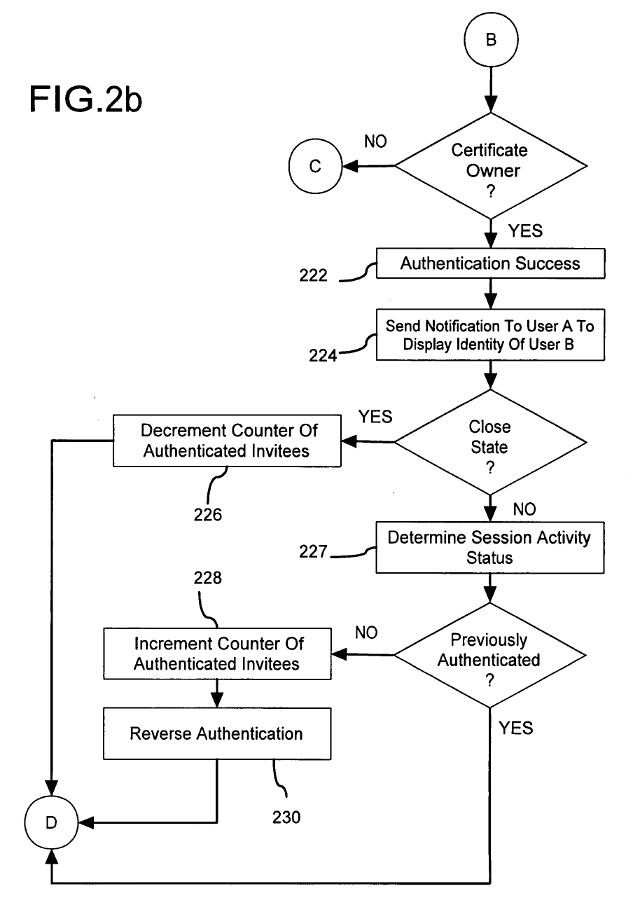

As shown in FIGS. 2a and 2b, through use of the authentication certificate and the digital signature, method 200 is facilitated by equipment at the premises of the other conference call invitees to authenticate the user that presented the authentication certificate and the digital signature. User equipment is defined herein to be telephony equipment that a conference call invitee (e.g., User A, User B, etc) uses to engage in a conference call session and conference call authentication apparatus is defined herein to be the equipment with which the user equipment of the conference call invitees jointly interact facilitate the conference call (e.g., a conference call server). After User A equipment initiates a conference call session (block 202) via conference call authentication apparatus and in response to User A equipment receiving data from User B (block 204), conference call authentication apparatus determines if the received data is data related to facilitating user authentication (block 206). If the conference call authentication apparatus determines that the received data is not related to facilitating user authentication, the method continues with equipment receiving data from User B equipment and determining if the received data is data related to facilitating user authentication. If the conference call authentication apparatus determines that the received data is related to facilitating user authentication (i.e., includes an authentication certificate for User B), the conference call authentication apparatus parses the received authentication certificate of User B (block 208) to access components of the User B authentication certificate and to determine the current conference call state. Examples of conference call states include opening a session, participating in a current instance of a conference call session and closing (i.e., ending) participation in a current instance of a conference call session. In conjunction with parsing the received authentication certificate of User B, the conference call authentication apparatus retrieves a public key corresponding to the authentication certificate from a pre-configured Certificate Authority (CA) root certificate (block 210) and cryptographically checks the validity of the authentication certificate using the root certificate public key (block 212). The CA) root certificate is authoritative for both User A and User B.

If the conference call authentication apparatus determines that the authentication certificate is not authentic or not authenticatable, the conference call authentication apparatus recognizes authentication failure (block 214) and causes a corresponding policy-driven reaction to be performed (block 216). Thereafter, the current instance of authentication ends and the method resumes with the conference call authentication apparatus receiving data from User B and determining if the received data is data related to facilitating user authentication. If the conference call authentication apparatus determines that the authentication certificate is authentic, the conference call authentication apparatus retrieves User B public key from the authentication certificate (block 218), followed by computing an asymmetric key cryptography function on the received User B signature using the retrieved User B public key (block 220). In this manner, a result of the asymmetric key cryptography function can be compared with a clear text version of the signature such that a match between the result and the clear text version of the signature indicates that User B is in possession of the private key. If through such asymmetric key cryptography function the conference call authentication apparatus determines that User B is not the certificate owner (i.e., public and private keys do not correspond), the conference call authentication apparatus recognizes authentication failure (block 214), causes a corresponding policy-driven reaction to be performed (block 216), and the method proceeds accordingly. If the conference call authentication apparatus determines that User B is the certificate owner (i.e., public and private keys correspond), the conference call authentication apparatus recognizes successful authentication (block 222) and sends a notification (block 224) for causing an identity of User B and current conference call state for User B to be send to User A equipment (e.g., for display thereon, audible output therefrom, etc). The identity of User B corresponds to authenticated information contained in the authentication certificate.

The conference call authentication apparatus includes a counter that maintains the number of active invitees in the conference call session. If the conference call state associated to User B is “Close” (i.e., User B leaving the call), the counter associated with User A is decremented (block 226). Otherwise, the conference call authentication apparatus determines a session activity status of User B (block 227). For example, the authentication of User B may be a period check of such authentication after already being authenticated or may be the initial authentication of User B. If user B has not been previously been authenticated in the conference call session, the counter is incremented (block 228) and a reverse authentication process is triggered to provide mutual authentication of User A to User B (block 230). The reverse authentication process is performed in accordance with blocks 204-230 of FIGS. 2a and 2b to authenticate User A to User B (i.e., the same authentication methodology as applied to User B).

In one embodiment of the present invention, identification information for all authenticated conference call invites in a conference call session is provided to only a conference call session chairperson, who is one of the authenticated conference call invitees. In another embodiment (e.g., where all conference call invitees are mutually authenticated), identification information for each one of the authenticated conference call invites in a conference call session is provided to each other authenticated conference call invitee. Thus, the present invention is not limited to mutual authentication of all conference call invitees.

Referring to FIG. 3, in conjunction with facilitating authentication of conference call invitees in accordance with the present invention, method 300 provides for alerting a conference call invitee as to whether or not there is any unauthenticated conference call invitees. Either periodically or upon request, conference call invitee equipment enters in a checking mode (block 302). For example, in one embodiment, a conference call server facilitating communication between conference call invitee equipment gives the ability to retrieve the number of entities (i.e., user equipments) connected to a conference call. In response to the conference call invitee equipment entering in the checking mode, the number of entities connected to the conference call (i.e., connected entities as opposed to authenticated invitees) is determined through a function call to the conference call server by each one of the authenticated conference call invitees (block 304). After determining the number of connected entities, the conference call invitee equipment checks the number of connected entities against the number of authenticated conference call invitees (block 306). Whenever this check yields a discrepancy between the number of connected entities and the number of authenticated conference call invitees, a warning notification to that effect is sent to the equipment of one of more of the authenticated call invitees (block 308). Preferably, but not necessarily, the warning notification includes the number of non-authenticated invitees connected to the conference call. In this manner, a mechanism is provided for allowing only authenticated conference call invitees to be included in a conference call. Typically, such a discrepancy will be the case where there are more connected entities than authenticated invitees. However, the case may also exist where the discrepancy is that there are fewer connected entities than authenticated invitees.

It is disclosed herein that known conference call bridges support the reporting of the number of participants to the conference call chair. Such functionality is provided for guaranteeing that uninvited conference call invitees cannot listen to the conference call audio using conference call equipment not under control of invited conference call invitees.

With respect to carrying out authentication of conference call invitees in accordance with the present invention, during conference call set-up, a conference call chairperson can coordinate the transmission of authentication certificates by the conference call invitees. In one embodiment, the conference call chairperson can ask each participant to send their certificates over the audio channel, while muting all other participants. Thus, in at least one embodiment, conference call authentication apparatus includes equipment used by the chairperson to engage in the conference call. As an alternative approach, a call conference bridge (e.g., server) can carry out the task of authenticating participants by requesting and validating their certificates. The bridge may also report any authentication failures to the conference call chairperson.

Multiple types of entities have the need for an end-to-end authentication mechanism to ensure that participants in a conference call are authorized and/or intended invitees. As can be seen, the present invention provide for seamless and strong end-to-end authentication for participants in a conference call. Furthermore, functional implementations of the present invention have a low intrusive footprint and will not require any significant change or upgrade into already deployed conference call bridge switch/servers and related network applications.

As will now be discussed in greater detail, authentication of conference call invitees in accordance with the present invention relies on an authenticated caller name registry. The caller name registry may be maintained on a global level, regional level, local level or other level. The present invention is not limited to a particular range for which the registry covers. For the purposes of this disclosure, whenever an entity (e.g., conference call invitee) requires access to the authenticated conference call feature in a specific location area, that entity registers identification information with the local authority managing the registry of authenticated caller for this area or jurisdiction. Upon completion of the registration process, that entity is issued with an authentication certificate (e.g., X.509 certificate) having the identification information embedded therein and being signed by an authenticated caller name-recognized certificate authority. Phone endpoints associated with the entity are then provisioned with such authentication certificates on a per call basis to assert the authenticity of the provided caller name in a particular jurisdiction.

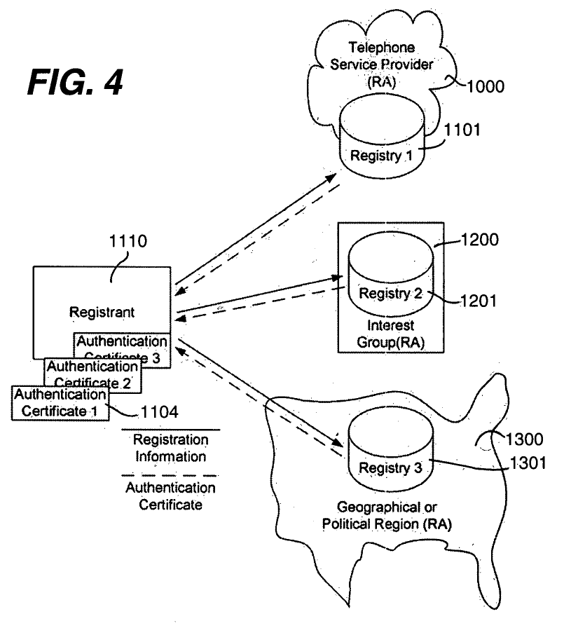

FIG. 4 is a schematic diagram of an exemplary registration infrastructure and associated process for registration of identification information in accordance with the present invention. In this example, a registrant 1110 registers with three separate registries: registry 1101 is operated by a registration authority (RA) that is a network service provider 1100, registry 1201 is operated by a RA that is an interest group (such as a trade association), and registry 1301 is operated by a RA that is a geographical or political region (perhaps a government or other official entity). Registrant 1110 registers in this manner to provide authenticated identification information to information recipients that subscribe to any one of the available registries. That is, registrant 1110 can be authenticated to an information recipient if and only if the information recipient subscribes to one or more of the available registries, in this example, registries 1101, 1201 or 1301.

The respective RA operates each registry. Operating a registry is defined herein to include maintaining information contained in a registry. A RA may be any public or private organization interested in providing an identification information registry. A RA does not require approval from any authority to operate, but may seek endorsement by these authorities. End-users, service suppliers, and/or equipment suppliers can determine if any given registry is trustworthy, and subscribe to only those registries determined to be trustworthy. Each registry is composed of two main parts—the RA (Certification Authority in X.509 parlance) and a database of identification information. Each registry serves a predetermined subscriber group, region and/or a predefined interest group. A region served by one registry may overlap a region served by another registry, and two or more registries may serve the same region. Similarly, two or more different defined interest groups can overlap (e.g., doctors and the more narrowly defined interest group of pediatricians).

The registry 1101 is maintained by a network service provider 1100 that wishes to provide an authenticated information provider service to any company, public or government organization, or other registrant 1110 who wishes to provide authenticated identification information to information recipients served by the network service provider 1100. The registry 1201 is operated by the interest group 1200 such as, for example, the Canadian Bankers Association®, which maintains the registry 1201 to provide authenticated identification information and/or associated services to its bank members. The registry 1301 is associated with a geographical or political region such as, for example, New York State; the Province of Ontario; the City of Toronto; the greater Chicago area; etc. and is maintained by a corresponding government agency or other official entity 1300.

In one embodiment, the only responsibility borne by the RAs 1100, 1200 or 1300 is to ensure proof of identity of any registrant 1110 and to ensure that it does not register any duplicate identification information for different registrants 1110. In this embodiment, the registry 1101 (which consists of the database and the RA) can be freely inspected by the public and it is at least partially the responsibility of registrants 1110 and other interested parties to police the registries 1101, 1201 and 1301 in order to ensure that a confusingly similar or misleading information provider identity is not registered by another registrant 1110. When a registrant 1110 is registered, the RA issues an authentication certificate 1104. The authentication certificate certifies that the registered information provider identity (i.e., identification information) is bound to a public key of the registrant, which is in turn implicitly paired with a private key of the registrant.

### Registration Process

The authentication certificate 1104 provided to each registrant 1110 by a registry can conform to any known authentication system, and each registry can use a different authentication system without departing from the scope of the present invention. When the registrant's identification information is recorded in a registry, an authentication certificate is provided to the registrant 1110 to permit information provider authentication to be performed. The authentication certificate can be based on any public key infrastructure scheme like X.509.

If X.509 certificates are used for the authentication certificates provided to the registrants 1110, in one embodiment of the present invention, the registration process proceeds as follows (i.e., using RA 1100 as an example).

The RA 1100 publishes its public key in its root certificate. The root certificate is a certificate that has the public key of the Registry (i.e., Certification) Authority. This public key is used to verify authentication certificates, so the root certificate must be imported into each device that will perform the information provider authentication. Typically, it is assumed a vendor or owner of data communication equipment will pre-load the root certificates of interest—including any local regional registries, all popular trade and professional registries, etc. in much the same way that Web browsers are preloaded with PKI root certificates today. Optionally, there is a way for allowing the end user to import more root certificates in the cases where the end user does business in multiple regions or is interested in a specialized registry. As understood by those skilled in the art, there is no limit to how many root public keys can be imported or the means for allowing such import.

Each interested party (i.e., registry applicant) wishing to become a registrant 1110, generates its own public/private key pair, submits the public key to the RA 1100 along with its identification information and any other required registration information and/or documentation.

If the RA 1100 determines that the interested party in fact owns or is otherwise in lawful possession of the identification information, the RA 1100 enters the identification information into the database 1100 and uses the private key of RA 1100 to sign an authentication certificate that includes the registrant's identification information and the registrant's public key. The RA 1100 therefore “vouches” that the registrant's public key is “the” public key that is bound to the registrant's identification information, and that the registrant is entitled to use that identification information.

The registrant 1110 now has a signed authentication certificate that attests to its identification information, and the registrant 1110 also has the private key that permits the registrant 1110 to validate that authentication certificate. It should be understood that the meaning of the authentication certificate is limited. The authentication certificate only signifies that the holder of the private key (which should be registrant 1110) is entitled to have its identification information displayed in the jurisdiction of the particular registration authority 1100 with which the registrant 1110 has registered.

Accordingly, in at least one embodiment of the present invention, conference call authentication functionality as disclosed herein relies upon registries descriptively referred to herein as “RealName registries” and associated authentication certificates (i.e., RealName certificates). Each RealName registry functions as a certificate authority for identification information. Examples of identification information in accordance with the present invention include, but are not limited to, a name by which an entity is recognized, an image specific to an entity, text specific to an entity, and a sound specific to an entity.

As depicted in FIG. 4, it is disclosed herein that RealName registries operate in effectively the same manner as trademarks registries. Each jurisdiction has its own trademarks registry, with possibly different rules for resolving ownership of a trademark and different rules for determining whether proposed identification information (e.g., a name) infringes an existing trademark. In fact, it is advantageous for RealName registries to be even more decentralized than trademark registries. For example, each jurisdiction can operate its own RealName registry, each profession can operate its own RealName registry, each trade association can operate its own RealName registry, etc. An information recipient (e.g., conference call invitee) can pick and choose which registries they are willing to import. At a minimum, the information recipient will typically import RealName registries for the local jurisdiction and the profession that the information recipient deals with. This arrangement of RealName registries sidesteps many problems, including the many legal disputes that plague the DNS system, the fraudulent (but visually identical) domain names, un-ambiguous rules on domain name ownership (e.g., does x-company Inc. own the x-company rocks.com site), etc.

With the registries in place, authentication of a conference call invitee can proceed. Each registry operates as an issuer of “Certificate of approved name” as well as a database of “approved” identification information (i.e., generally referred to as RealNames). The certificates (i.e., authentication certificates) can be accomplished in many ways, but the simplest is the X.509 authentication certificates that are used for existing DNS/SSL. X.509 is a standardized public key infrastructure (PKI). In X.509 parlance, each registry operates as the “Certificate Authority” and each authentication certificate is essentially a package embedding the RealName and the public key. This package is then signed by the private key of the certificate authority. In operation, the authentication certificates are configured to include essentially any type of identification information useful for reinforcing an entity's identity.

### Caller Authentication

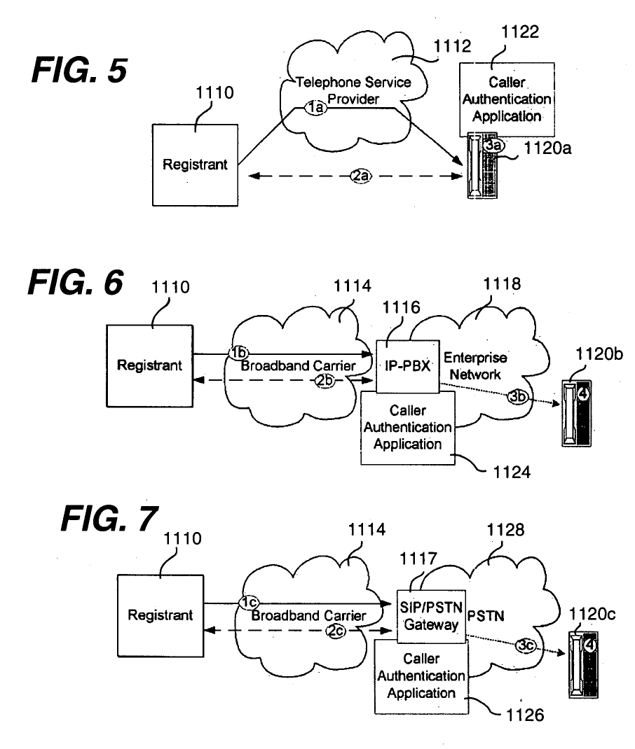

FIGS. 5-7 show examples of caller authentication in accordance with one embodiment of the invention. Note that caller authentication does not require a query of the registries 1101,1201, 1301. In one embodiment, the caller presents its certificate to the called party, or a proxy for the called party, as will be explained below in more detail. In one embodiment, caller authentication is performed after call set-up. After the data/voice path is being established, the caller sends its certificate as part of a protocol to verify ownership of the private key corresponding to the certificate. An authentication dialog can be initiated by adding extensions to VoIP signalling protocol or by exchanging a special first signalling packet.

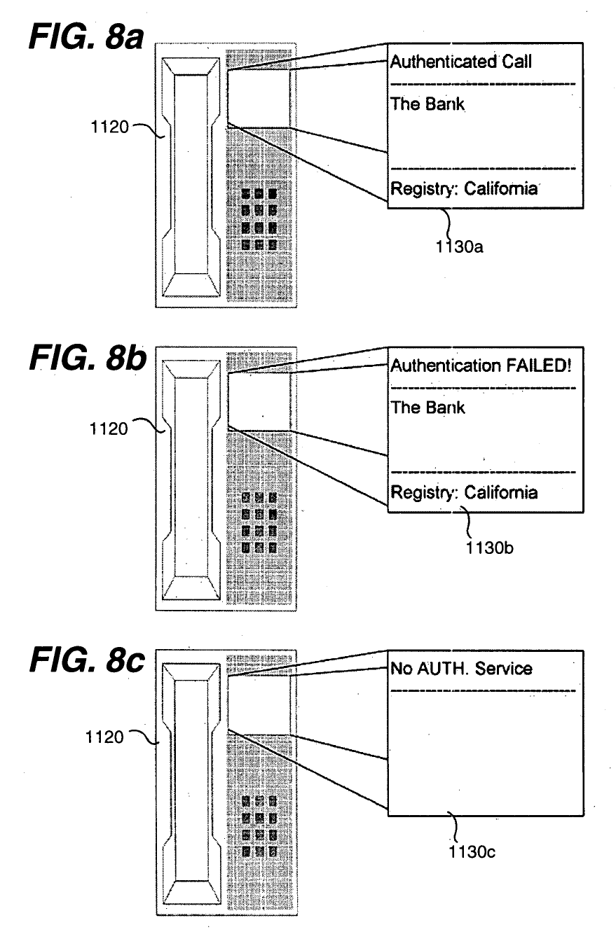

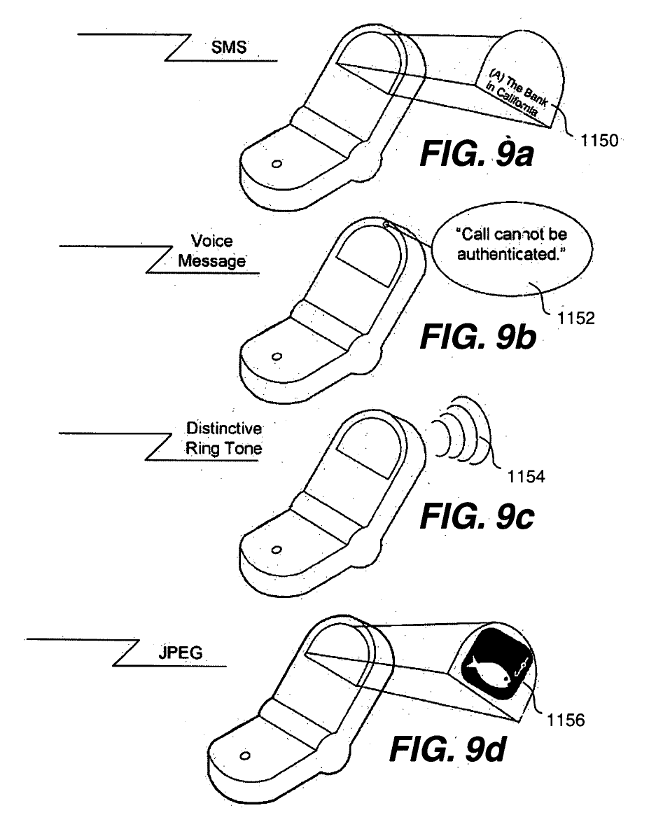

As shown in FIG. 5, in one embodiment of the invention the caller authentication is performed by the called party user device 1120a, which is for example an Internet Protocol (IP) telephone. The IP telephone 1120a is equipped with a caller authentication application 1122. This is the most secure form of caller authentication because the called party directly controls it. When the registrant 1110 initiates a call to the called party, call set-up (1a) proceeds through the telephone service provider network(s) in a manner well known in the art. The call set-up messages may carry regular caller information, but that information is ignored by the called party user device 1120a if a caller authentication dialogue (2a) is commenced when the registrant 1110 sends its authentication certificate, using one of the communications protocols referenced above. The caller authentication application 1122 conducts the authentication dialogue with equipment used by registrant 1110, and authenticates the authentication certificate obtained during the dialogue. The authenticated caller name is then conveyed (3a) to the called party, as will be explained below with reference to FIG. 8a-8c and 9a-9d.

As shown in FIG. 6, in accordance with another embodiment of the invention the caller authentication is performed by a public branch exchange, such as an Internet Protocol Public Branch Exchange (IP-PBX) 1116 which serves as a proxy for called parties connected to an enterprise network 1118. In this embodiment, call set-up (1b) proceeds by conventional means through one or more networks, in this example a broadband carrier network 1114. During or after call set-up the registrant 1110 initiates a caller authentication dialogue (2b) with the IP-PBX 1116, which is provisioned with a caller authentication application 1124. The IP-PBX authenticates the registrant's authentication certificates and conveys (3b) a caller authentication message to a user device 1120b of the called party. The user device displays the caller authentication message as will be described below in more detail with reference to FIGS. 8a-8c and 9a-9d.

As shown in FIG. 7, in accordance with another embodiment of the invention the caller authentication is performed by a network gateway 1117, such as a Session Initiation Protocol (SIP)/Public Switched Telephone Network (PSTN) gateway that serves as a proxy for called parties connected to a Public Switched Telephone Network (PSTN) 1128. In this embodiment, call set-up (1c) proceeds by conventional means through one or more networks, in this example a broadband carrier network 1114 to the SIP/PSTN gateway 1117. During or after call set-up the registrant 1110 initiates a caller authentication dialogue (2c) with the SIP/PSTN gateway 1117, which is provisioned with a caller authentication application 1126. The SIP/PSTN gateway 1117 authenticates the registrant's authentication certificate and conveys (3c) a caller authentication message to a user device 1120c of the called party using the standard caller name field in Signalling System 7 (SS7) Initial Address Message (IAM), for example. The user device displays the authentication message as will be described below in more detail with reference to FIGS. 8a-8c and 9a-9d.

FIGS. 8a-8c show examples of caller authentication messages conveyed to called parties in accordance with one embodiment of the invention. In these examples, the caller authentication messages displayed indicate whether the caller name has been authenticated; the caller name (optionally the logo, etc.); and the registry 1101, 1201, 1301 with which the caller has registered.

FIG. 8a shows an exemplary display format 1130a for an authenticated caller name. A first line of the display 1130a indicates that the caller name has been successfully authenticated. A second line of the display 1130a displays the authenticated caller name. The last line of the display displays the name of the RA, in this example a registry associated with the State of California.

FIG. 8b shows an exemplary display format 1130b for a caller that could not be authenticated because authentication failed. As understood by those skilled in the art, caller authentication may fail for any one of a number of reasons. For example: the caller may present a stolen authentication certificate for which the caller does not have the corresponding private key; the authentication certificate cannot be validated with the public key of the CA; a communications failure may have occurred; an authentication dialogue may have been interrupted; etc. A first line of the display 1130b indicates that the caller has not been successfully authenticated because caller authentication has failed. A second line of the display 1130b displays the caller name contained in the certificate, if available. The last line of the display 1130c displays the name of the registry contained in the certificate, if available. To further highlight the fact that authentication failed, the message can be displayed in a bright color, red for example, etc.

FIG. 8c shows an exemplary display format 1130c for a caller that could not be authenticated because the caller did not present a certificate. The first line of the display 1130c indicates that the caller has not attempted authentication and the rest of the lines may be blank, as shown, or may display a caller name and/or number extracted from the call set-up signalling messages, in which case the fact that authentication was not attempted should be emphasized by highlighting or blinking the no authentication service message.

As will be understood by those skilled in the art, the display formats 1130a-1130c may not always be practical or desired by a called party. It is therefore contemplated that other forms of call authentication indications may be conveyed to a called party. FIGS. 9a-9d illustrate alternate ways to convey an indication of authenticated caller name to a called party. Although the examples shown in FIGS. 9a-9d illustrate a specific type of user device (cellular telephone) it should be understood that such indications could be conveyed to most known types of telephone devices.

As shown in FIG. 9a, a caller authentication, or authentication failure, may be conveyed to a called party using an out-of-band message sent concurrently with or after a ringing signal is sent to the user device. In this example, a Short Message Service (SMS) message is sent. The SMS message includes an indication 1150 that the caller has been authenticated (A), or not authenticated (NA), which is not shown; and, the caller ID, in this example, “The Bank in California”.

As shown in FIG. 9b, alternatively an in-band voice message can be played when the called party answers the call, to indicate whether the caller could be authenticated. The in-band voice message may be played to the called party after the called party answers, but before the call is “cut through”, so that the calling party cannot forge the message. In this example, the called party receives a voice message 1152 indicating that the caller could not be authenticated.

As shown in FIG. 9c, in a further alternative a distinctive ring tone is sent to the called party device. One ring tone 1154 indicates an authenticated caller and another ring tone (not shown) indicates a caller name that could not be authenticated.

As shown in FIG. 9d, in yet a further alternative an image, for example a .jpeg image is sent to the called party device to indicate whether the caller has been authenticated. In this example, a .jpeg image 1156 indicates that the caller could not be authenticated. Another .jpeg image (not shown) is used to indicate an authenticated caller name.

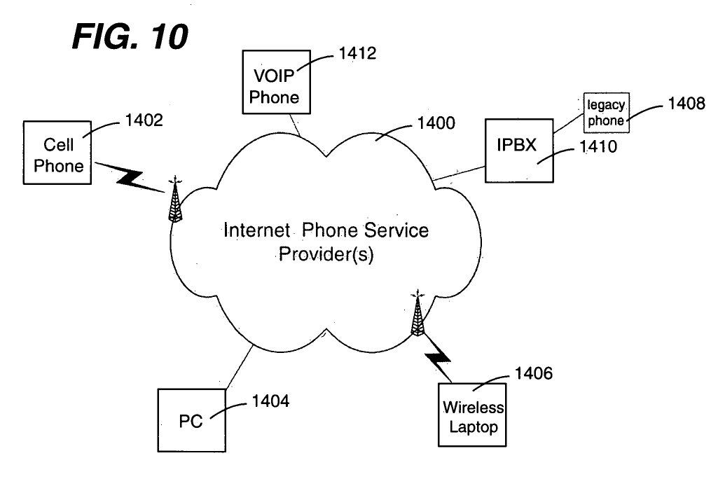

Referring to FIG. 10, various embodiments of conference call targets that communication with each other in a wired and/or wireless manner via a communications network system 1400 (e.g., an Internet Protocol (IP) based communication network system) are depicted. Such targets can each have embedded thereon computer-executable instructions for carrying out conference call authentication functionality in accordance with the present invention. Examples of such targets include, but are not limited to, a cell phone 1402, a personal computer 1404, a portable computer 1406, a legacy phone 1408 and a serving IP private branch exchange 1410, and a voice over IP (VoIP) phone 1412.

Referring now to computer-executable instructions in accordance with the present invention, it will be understood from the disclosures made herein that methods, processes and/or operations configured for facilitating conference call authentication functionality as disclosed herein are tangibly embodied by computer readable medium having instructions thereon that are configured for carrying out such functionality. In one specific embodiment, the instructions are tangibly embodied for carrying out one or more of the methodologies disclosed in reference to FIGS. 1-9. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the present invention include a compact disk, a hard drive, RAM or other type of storage apparatus that has imaged thereon instructions (e.g., a computer program) adapted for facilitating carrying out conference call authentication functionality in accordance with the present invention.

A conference call system in accordance with the present invention can be embodied in any number of configurations. In one embodiment, such a conference call system is a server including computer-executable instructions for carrying out at least a portion of conference call functionality in accordance with the present invention. In another embodiment, such a conference call system includes a dedicated conference call unit having computer-executable instructions for carrying out at least a portion of conference call functionality in accordance with the present invention. In still another embodiment, such a conference call system includes a plurality of conference call invitee phones each having computer-executable instructions for carrying out at least a portion of conference call functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method, comprising:
authenticating a plurality of invitees to a conference call session during the conference call session, wherein said authenticating includes cryptographically verifying an identity of each one of said conference call invitees using information associated with a respective authentication certificate; and
providing identification information contained in the authentication certificate of each one of said conference call invitees in response to successful authentication thereof, wherein said identification information is provided to at least one of said conference call invitees.

2. The method of claim 1, further comprising:
determining a number of authenticated conference call invitees during the conference call session;
determining a number of connected conference call entities in conjunction with determining the number of authenticated conference call invitees; and
providing a discrepancy notification in response to determining a discrepancy between said authenticated conference call invitees and said connected conference call entities.

3. The method of claim 1 wherein authenticating said conference call invitees includes mutually authenticating each one of said conference call invitees to each other conference call invitee.

4. The method of claim 3 wherein mutually authenticating each one of said conference call invitees to each other conference call invitee includes:
a first one of said conference call invitees facilitating authentication of a second one of said conference call invitees; and
the second one of said conference call invitees facilitating authentication of the first one of said conference call invitees in response to successful authentication of the second one of said conference call invitees by the first one of said conference call invitees and in response to determining that the second one of said conference call invitees has not already been authenticated by the first one of said conference call invitees during the conference call session.

5. The method of claim 4, further comprising:
determining a number of authenticated conference call invitees during the conference call session;
determining a number of connected conference call entities in conjunction with determining the number of authenticated conference call invitees; and
providing a discrepancy notification in response to determining a discrepancy between said authenticated conference call invitees and said connected conference call entities.

6. The method of claim 1, further comprising:
maintaining a count of authenticated conference call invitees;
determining a conference call session state for each one of said authenticated conference call invitees;
adjusting the count accordingly in response to a change in the conference call session state for any one of said authenticated conference call invitees.

7. The method of claim 6, further comprising:
determining a number of authenticated conference call invitees during the conference call session;
determining a number of connected conference call entities in conjunction with determining the number of authenticated conference call invitees; and
providing a discrepancy notification in response to determining a discrepancy between said authenticated conference call invitees and said connected conference call entities.

8. A conference call server, comprising:
computer-executable instructions for authenticating a plurality of invitees to a conference call session during the conference call session, wherein said authenticating includes cryptographically verifying an identity of each one of said conference call invitees using information associated with a respective authentication certificate; and
computer-executable instructions for providing identification information contained in the authentication certificate of each one of said conference call invitees in response to successful authentication thereof, wherein said identification information is provided to at least one of said conference call invitees.

9. The conference call server of claim 8, further comprising:
computer-executable instructions for determining a number of authenticated conference call invitees during the conference call session;
computer-executable instructions for determining a number of connected conference call entities in conjunction with determining the number of authenticated conference call invitees; and
computer-executable instructions for providing a discrepancy notification in response to determining a discrepancy between said authenticated conference call invitees and said connected conference call entities.

10. The conference call server of claim 8 wherein authenticating said conference call invitees includes mutually authenticating each one of said conference call invitees to each other conference call invitee.

11. The conference call server of claim 10 wherein mutually authenticating each one of said conference call invitees to each other conference call invitee includes:
a first one of said conference call invitees facilitating authentication of a second one of said conference call invitees; and
the second one of said conference call invitees facilitating authentication of the first one of said conference call invitees in response to successful authentication of the second one of said conference call invitees by the first one of said conference call invitees and in response to determining that the second one of said conference call invitees has not already been authenticated by the first one of said conference call invitees during the conference call session.

12. The conference call server of claim 11, further comprising:
computer-executable instructions for determining a number of authenticated conference call invitees during the conference call session;
computer-executable instructions for determining a number of connected conference call entities in conjunction with determining the number of authenticated conference call invitees; and
computer-executable instructions for providing a discrepancy notification in response to determining a discrepancy between said authenticated conference call invitees and said connected conference call entities.

13. The conference call server of claim 8, further comprising:
computer-executable instructions for maintaining a count of authenticated conference call invitees;
computer-executable instructions for determining a conference call session state for each one of said authenticated conference call invitees;
computer-executable instructions for adjusting the count accordingly in response to a change in the conference call session state for any one of said authenticated conference call invitees.

14. The conference call server of claim 13, further comprising:
computer-executable instructions for determining a number of authenticated conference call invitees during the conference call session;
computer-executable instructions for determining a number of connected conference call entities in conjunction with determining the number of authenticated conference call invitees; and
computer-executable instructions for providing a discrepancy notification in response to determining a discrepancy between said authenticated conference call invitees and said connected conference call entities.

15. A conference call system configured to: i.) authenticate a plurality of invitees to a conference call session during the conference call session, wherein said authenticating includes cryptographically verifying an identity of each one of said conference call invitees using information associated with a respective authentication certificate; ii.) determine a discrepancy between a number of authenticated conference call invitees and a number of connected entities during the conference call session; and iii.) adjust a count of authenticated conference call invitees accordingly in response to a change in a respective conference call session state for any one of said authenticated conference call invitees.

16. The conference call system of claim 14 further configured to providing a discrepancy 10 notification in response to determining a discrepancy between said authenticated conference call invitees and said connected conference call entities.

17. The conference call system of claim 14 wherein being configured to authenticate said conference call invitees includes being configured to mutually authenticate each one of said conference call invitees to each other conference call invitee.

18. The conference call system of claim 17 wherein being configured to mutually authenticating each one of said conference call invitees to each other conference call invitee includes being configured to facilitate:
a first one of said conference call invitees authenticating a second one of said conference call invitees; and
the second one of said conference call invitees authenticating the first one of said conference call invitees in response to successful authentication of the second one of said conference call invitees by the first one of said conference call invitees and in response to determining that the second one of said conference call invitees has not already been authenticated by the first one of said conference call invitees during the conference call session.

19. A method, comprising:
authenticating a plurality of invitees to a conference call session during the conference call session, wherein said authenticating includes cryptographically verifying an identity of each one of said conference call invitees using information associated with a respective authentication certificate of each one of said conference call invitees;
determining a discrepancy between a number of authenticated conference call invitees and a number of connected entities during the conference call session; and
adjusting a count of authenticated conference call invitees accordingly in response to a change in a respective conference call session state for any one of said authenticated conference call invitees.

20. The method of claim 19, further comprising:
providing a discrepancy notification in response to determining a discrepancy between said authenticated conference call invitees and said connected conference call entities;
wherein determining the discrepancy includes determining a number of authenticated conference call invitees during the conference call session and determining a number of connected conference call entities in conjunction with determining the number of authenticated conference call invitees; and
wherein authenticating said conference call invitees includes mutually authenticating each one of said conference call invitees to each other conference call invitee.
